(19) United States
(12) Patent Application Publication
(10) Pub. No.: US 2007/0106049 A1
(43) Pub. Date: May 10, 2007

(54) Method for the production of polyol mixtures

(76) Inventors: Jan-Michael Dreisorner, Hullhorst (DE); Johann Knake, Drebber (DE); Maria Thomas, Muhlen (DE); Marion Wenzel, Stemwede-Haldem (DE); Bernd Zaschke, Schonfeld (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/573,345

(22) PCT Filed: Sep. 24, 2004
(86) PCT No.: PCT/EP04/10722

§ 371 Date: Mar. 24, 2006

(30) Foreign Application Priority Data
Sep. 29, 2003 (DE) 10345603.1

(51) Int. Cl. C08F 20/00; C08G 18/00

(52) U.S. Cl. 528/76; 525/440

(57) ABSTRACT

The invention relates to a process for preparing mixtures of polyols for further processing to give polyurethanes, comprising at least one graft polyol, which comprises carrying out the mixing of the polyols between the preparation of the polyols and the preparation of the polyurethanes, by means of a continuous mixing process.

The invention relates to a process for preparing polyol mixtures which can be used for preparing polyurethanes.

The preparation of polyurethanes via reaction of polyisocyanates with compounds having at least two hydrogen atoms reactive toward isocyanate groups has been known for a long time and has been widely described. The compounds used which have at least two hydrogen atoms reactive toward isocyanate groups are mostly polyols, in particular polyether alcohols and/or polyester alcohols. Polyols comprising fillers are used for many applications. The fillers used are often the polymers of ethylenically unsaturated compounds, in particular styrene and/or acrylonitrile, these being produced in situ within the polyol. Polyols of this type, often also termed polymer polyols or graft polyols, are likewise well-known and are described in more detail by way of example in Kunststoffhandbuch, volume 7 “Polyurethane”, 3rd edition 1993, Carl-Hanser-Verlag Munich, Vienna, in section 3.3.1.1.

The graft polyols are mostly used in the preparation of flexible polyurethane foams. A successful industrial method prepares graft polyols with high content of polymer, also termed filler below, and then mixes this material with unfilled polyol in order to adapt the content of fillers to the particular requirements. The range of graft polyols used can thus be reduced, the result being better capacity-utilization of production plants and simplification of inventory-holding. The graft polyols are therefore usually used in a mixture with other polyols.

For example, PCT/EP03/02576 describes the production of graft polyols with content solids in the range from 30 to 65% by weight, and then adjustment to the desired solids content in the polyol mixture via mixing with other polyols. That mixing takes place batchwise, mostly in stirred tanks.

This mixing of the graft polyols with the other polyols mostly takes place immediately prior to the preparation of the polyurethanes. It is also usual to meter the individual polyols separately from one another into the metering equipment for polyurethane preparation. However, it has been found here that the resultant polyurethanes have inadequate quality. For example, the foams have a non-uniform and unsatisfactory foam structure, and tend to crack.

It was therefore an object of the invention to find a process for preparing polyol mixtures which comprise graft polyols and which can be processed to give polyurethanes, in particular polyurethane foams with good quality.

Surprisingly, it has now been found that if the mixing takes place prior to the actual polyurethane preparation and if the quality of mixing is high, stable mixtures of graft polyols with other polyols are obtained and can be further processed to give polyurethanes with good quality, in particular to give polyurethane foams with a uniform foam structure and good mechanical properties.

The high quality of mixing may preferably be achieved via continuous mixing, in particular using a static mixer. This embodiment gives particularly thorough and non-aggressive mixing.

The invention therefore provides a process for preparing mixtures of polyols for further processing to give polyurethanes, comprising at least one graft polyol, which comprises carrying out the mixing of the polyols between the preparation of the polyols and the preparation of the polyurethanes, by means of a continuous mixing process.

The invention further provides a process for preparing polyurethanes by reacting
a) polyisocyanates with
b) compounds having at least two hydrogen atoms reactive toward isocyanate groups,
   which comprises using, as compounds b) having at least two hydrogen atoms reactive toward isocyanate groups, mixtures of polyols which comprise at least one graft polyol, and carrying out the mixing of the polyols between the preparation of the polyols and the preparation of the polyurethanes, and by means of a continuous mixing process.

The invention further provides the materials prepared by the inventive processes, these materials being polyol mixtures and, respectively, polyurethanes. The polyurethanes prepared by the inventive process are mostly flexible polyurethane foams.

The graft polyols used to prepare the polyol mixtures may be polyether alcohols or polyester alcohols. Suitable graft polyether alcohols are described by way of example in PCT/EP03/02576. Graft polyester alcohols are described by way of example in EP 622384.

They are prepared as stated above via polymerization of olefinically unsaturated monomers, mostly styrene and acrylonitrile, in polyols, very often termed carrier polyols. In order to give the graft polyols stability and inhibit settling of the particles, it is preferable to carry out the polymerization in the presence of polyols which incorporate unsaturated groups, frequently termed macromers, or to use carrier polyols having unsaturated groups.

The form in which the polymers are present within the carrier polyols is usually that of particles. The diameter of these is mostly in the range from 0.1 to 4 μm. Larger-diameter particles would lead to problems during the further processing of the graft polyols.

The hydroxy number of graft polyols suitable for preparing flexible polyurethane foams is mostly from 10 to 50 mg KOH/g, preferably from 15 to 45 mg KOH/g. The carrier polyols used are mostly conventional flexible foam polyether alcohols. These mostly have a hydroxy number in the range from 20 to 100 mg KOH/g, and are usually prepared via addition reactions of alkylene oxides onto di- and trihydric alcohols, such as glycerol, trimethylolpropane, ethylene glycol, or propylene glycol.

Alcohols which may be used and may be mixed with the graft polyols are mostly the polyether and/or polyester alcohols that are known and conventional for producing polyurethane foams.

By way of example, suitable polyester alcohols may be prepared from organic dicarboxylic acids having from 2 to 12 carbon atoms, preferably aliphatic dicarboxylic acids having from 8 to 12 carbon atoms, with polyhydric alcohols, preferably diols, having from 2 to 12 carbon atoms, preferably from 2 to 6 carbon atoms. Examples of dicarboxylic acids which may be used are: succinic acid, glutaric acid, adipic acid, suberic acid, azelaic acid, sebacic acid, decanedicarboxylic acid, maleic acid, fumaric acid, phthalic acid, isophthalic acid, terephthalic acid, and the isomeric naphthalene-dicarboxylic acids, preferably adipic acid. The dicarboxylic acids here may be used either individually or as in a mixture with one another. Instead of the free dicarboxylic acids, it is also possible to use the corresponding dicarboxylic acid derivatives, such as dicarboxylic esters of alcohols having from 1 to 4 carbon atoms, or dicarboxylic anhydrides.

Examples of di- and polyhydric alcohols, in particular diols, are ethanediol, diethylene glycol, 1,2- or 1,3-propanediol, dipropylene glycol, 1,4-butanediol, 1,5-pentanediol, 1,6-hexanediol, 1,10-decanediol, glycerol, and trimethylolpropane. Preference is given to the use of ethanediol, diethylene glycol, 1,4-butanediol, 1,5-pentanediol, 1,6-hexanediol, or a mixture composed of at least two of the diols mentioned, in particular a mixture composed of 1,4-butanediol, 1,5-pentanediol, and 1,6-hexanediol. It is also possible to use polyester polyols derived from lactones, e.g. ε-caprolactone, or hydroxycarboxylic acids, e.g. hydroxycaproic acid, and hydroxybenzoic acids.

The hydroxy number of the polyester alcohols is preferably in the range from 40 to 100 mg KOH/g.

The polyether alcohols used are prepared by known processes, e.g. via anionic polymerization, using alkali metal hydroxides or alkali metal alcoholates as catalysts, and with addition of at least one starter molecule which contains from 2 to 3 reactive hydrogen atoms, starting from one or more alkylene oxides having from 2 to 4 carbon atoms in the alkylene radical. By way of example, suitable alkylene oxides are tetrahydrofuran, propylene 1,3-oxide, butylene 1,2- or 2,3-oxide, and preferably ethylene oxide and propylene 1,2-oxide. The alkylene oxides may be used individually, alternating in succession, or as mixtures. Preference is given to mixtures of propylene 1,2-oxide and ethylene oxide, amounts of from 10 to 50% of the ethylene oxide being used as ethylene oxide end-block (EO cap), so that the resultant polyols have more than 70% of primary OH end groups.

As starter molecule, use may be made of water or of di- and trihydric alcohols, such as ethylene glycol, 1,2-propanediol, 1,3-propanediol, diethylene glycol, dipropylene glycol, 1,4-butanediol, glycerol, trimethylolpropane, etc. The functionality of the polyether alcohols, preferably polyoxypropylene-polyoxyethylene polyols, is from 2 to 3, and their molecular weights are from 1000 to 8000, preferably from 2000 to 7000.

As stated, preferred mixing apparatus which may be used are static mixers. Apparatus of this type are well-known to the person skilled in the art. By way of example, EP 0 097 458 describes an apparatus of this type for the mixing of liquids.

Static mixers are usually tubular apparatus with fixed internals, these serving to mix the individual streams of materials across the tube cross section. Static mixers may be used in continuous processes for carrying out various fundamental processing operations, such as mixing, exchange of material between two phases, chemical reactions, or heat transfer.

The starting materials are homogenized via a pressure drop generated by means of a pump. It is possible to distinguish two fundamental principles of mixing, depending on the nature of the flow in the static mixer.

In laminar-flow mixers, homogenization takes place via separation and rearrangement of the streams of the individual components. Progressive doubling of the number of layers reduces the layer thicknesses until complete mixing at the macro level has been achieved. Mixing at the micro level via diffusion processes is residence-time-dependent. Laminar-flow mixing operations are carried out in helical mixers or mixers with intersecting ducts. The laminar flow is similar to normal tubular flow with low shear forces and with narrow residence time distribution.

In turbulent-flow mixers, vortices are specifically created with the purpose of homogenizing the individual streams of materials. Mixers with intersecting ducts are suitable for this purpose, as are specific turbulence mixers.

Both types of mixers may be used for the inventive process.

The internals used are generally composed of flow-dividing and -diverting, three-dimensional geometric bodies which result in rearrangement, mixing and recombination of the individual components.

Static mixers are commercially available mixing apparatus and are supplied, by way of example, by Fluitec Georg AG, Neftenbach, Switzerland, for various application sectors.

Use of the static mixers described above permits very good homogenization. The resultant polyol mixtures are storage-stable and can be mixed without difficulty with the other components required for preparing the polyurethanes, further details of those components being given below.

The inventive polyol mixtures may be reacted with polyisocyanates to give polyurethanes, in particular to give flexible polyurethane foams.

The polyisocyanates used comprise the usual and known (cyclo)aliphatic and/or in particular aromatic polyisocyanates. Diphenyl diisocyanate (MDI) and/or tolylene diisocyanate (TDI) are in particular used to produce the inventive flexible polyurethane foams. The polyisocyanates may be used either in the form of the pure compounds or else in modified form, e.g. as uretdiones, isocyanurates, allophanates, or biurets, but in particular in the form of reaction products containing urethane groups and isocyanate groups, known as isocyanate prepolymers.

In addition to the polyols, use may also be made of low-molecular-weight chain extenders and crosslinking agents. These comprise low-molecular-weight, polyhydric alcohols, preferably diols and/or triols, with molecular weights smaller than 400 daltons, preferably from 60 to 300 daltons, particularly preferably from 60 to 200 daltons. Examples of diols which may be used are aliphatic, cycloaliphatic, and/or araliphatic diols, e.g. alkanediols having from 2 to 14, preferably from 2 to 6, carbon atoms, and/or dialkylene glycols having from 4 to 8, preferably from 4 to 6, carbon atoms. Examples of these are glycerol, trimethylolpropane, pentaerithrytol, and/or diamines, such as ethylenediamine, and/or amino alcohols, such as ethanolamine.

The flexible polyurethane foams are preferably produced in the presence of catalysts, blowing agents, and also conventional auxiliaries and/or additives.

The blowing agent used for the inventive process is mostly water, which reacts with isocyanate groups to form carbon dioxide. The amounts of water advantageously used depend on the desired density of the foams and are from 0.1 to 8 parts by weight, preferably from 1.5 to 5 parts by weight, based on 100 parts by weight of compounds having at least two hydrogen atoms reactive toward isocyanate groups.

Mixed with water, use may also be made, if appropriate, of what are known as physical blowing agents. These are liquids which are inert toward the constituents of the formulation and have boiling points below 100° C., preferably below 50° C., in particular from −50° C. to 30° C., at atmospheric pressure, and which therefore vaporize when subjected to the exothermic polyaddition reaction. Examples of these liquids whose use is preferred are hydrocabons, such as pentane, n-butane, isobutane and propane, ethers such as dimethly ether and diethyl ether, ketones, such as acetone and methyl ethyl ketone, ethyl acetate, and preferably halogenated hydrocarbons, such as methylene chloride, trichlorofluoromethane, dichlorodifluoromethane, dichloromonofluoromethane, dichlorotetrafluoroethane, and 1,1,2-trichloro-1,2,2-trifluoroethane. Mixtures of these low-boiling liquids with one another, and/or with other substituted or unsubstituted hydrocarbons may also be used.

The amount of physical blowing agents alongside water may be determined as a function of the desired foam density in a simple manner, and is from about 0 to 50 parts by weight, preferably from 0 to 20 parts by weight, per 100 parts by weight of compounds having at least two hydrogen atoms reactive toward isocyanate groups.

To accelerate the reaction between the compounds having at least two hydrogen atoms reactive toward isocyanate groups and water with the polyisocyanates, conventional polyurethane catalysts are incorporated into the reaction mixture. It is preferable to use basic polyurethane catalysts, such as tertiary amines, e.g. dimethylbenzylamine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, dimethylpiperazine, pyridine, 1,2-dimethylimidazole, 1-azabicyclo-[3.3.0]octane, dimethylaminoethanol, 2-(N,N-dimethylaminoethoxy)ethanol, N,N′,N″-tris(dialkylaminoalkyl)hexahydrotriazine, and in particular triethylenediamine. However, metal salts are also suitable, e.g. ferrous chloride, zinc chloride, lead octoate, and preferably tin salts, such as stannous dioctoate, stannous diethylhexoate, and dibutyltin dilaurate, and also in particular mixtures composed of tertiary amine and of organic tin salts. It is advantageous to use from 0.1 to 10% by weight, preferably from 0.5 to 5% by weight of catalyst based on tertiary amines, and/or from 0.01 to 0.5% by weight, preferably from 0.05 to 0.25% by weight, of metal salts, based on the weight of polyhydroxy compounds.

Auxiliaries and/or additives may also be incorporated into the reaction mixture. By way of example, mention may be made of hydrolysis stabilizers, other stabilizers, pore regulators, substances with fungistatic and bacteriostatic action, dyes, pigments, fillers, surfactants, and flame retardants.

By way of example, use may be made of surfactants which serve to promote the homogenization of the starting materials and, if appropriate, are also suitable for regulating the cell structure of the foams. By way of example, mention may be made of siloxane-oxyalkylene copolymers and other organopolysiloxanes, oxethylated alkylphenols, oxethylated fatty alcohols, paraffin oils, castor oil esters, or ricinoleic esters, the amounts used of these being from 0.2 to 8 parts by weight, preferably from 0.5 to 5 parts by weight, per 100 parts by weight of polyhydroxy compounds.

By way of example, suitable flame retardants are compounds containing phosphorus and/or containing halogen atoms, e.g. tricresyl phosphate, tris-2-chloroethyl phosphate, trischloropropyl phosphate, and tris-2,3-dibromopropyl phosphate.

Besides the abovementioned halogen-substituted phosphates, use may also be made of inorganic flame retardants, such as antimony trioxide, arsenic oxide, ammonium phosphate, and calcium sulfate, or melamine, to provide flame retardancy to the polyurethane foams.

It has generally proven advantageous to use from 5 to 50 parts by weight, preferably from 5 to 25 parts by weight, of the flame retardants mentioned per 100 parts by weight of polyhydroxy compound.

Further details concerning the starting materials used are found, by way of example, in Kunststoffhandbuch, volume 7, Polyurethane, edited by Günter Oertel, Carl-Hanser-Verlag, Munich, 3rd edition 1993.

To prepare the inventive polyurethanes, the organic polyisocyanates a) are reacted with the compounds having at least two active hydrogen atoms in the presence of the blowing agents, catalysts, and auxiliaries and/or additives mentioned. In this process, the inventive polyol mixture, and also the blowing agents, catalysts, and auxiliaries and/or additives mentioned, are frequently combined prior to the reaction to give what is known as a polyol component, this being brought into contact with the isocyanate component. The polyol component may likewise be prepared continuously by means of a static mixer.

The invention permits the simple preparation of polyol mixtures derived from graft polyols. The polyol mixtures prepared using the inventive polyol mixtures have better cell structure than those where another method of mixing was used.

The examples below are intended to describe the invention in greater detail. In each case, a flexible polyurethane foam of envelope density 30 kg/m³ was produced.

### EXAMPLE 1

27 parts by weight of a graft polyol with a solids content of 40% by weight and a hydroxy number of 27.3 mg KOH/g, prepared by in-situ polymerization of acrylonitrile and styrene in a ratio of 2:1 by weight in a polyether alcohol with a hydroxy number of 46 mg KOH/g, prepared by an addition reaction of propylene oxide and ethylene oxide onto glycerol, were mixed with 73 parts by weight of a polyether alcohol, by means of a Fluitec CSE-X® static mixer. The solids content of the mixture was 10% by weight.

This mixture was mixed with 3.5 parts by weight of water, 1.1 parts by weight of Tegostab® BF 2370 foam stabilizer, 0.2 part by weight of amine catalyst Lupragen® N201/N206 in a ratio of 3:1 by weight, and 0.18 part by weight of stannous octoate.

This mixture was foamed 20/80 with tolylene diisocyanate in a laboratory system, the index being 110.

Table 1 gives the foaming performance and the mechanical properties of the foam.

### COMPARATIVE EXAMPLE 1

The procedure was as in example 1, except that the polyether alcohols were metered separately into the mixing head.

Table 1 gives the foaming performance and the mechanical properties of the foam.

### EXAMPLE 2

The procedure was as in example 1, except that 36 parts by weight of the graft polyol and 64 parts by weight of the polyether alcohol were used. The solids content of the polyol mixture was 15% by weight.

Table 1 gives the foaming performance and the mechanical properties of the foam.

### COMPARATIVE EXAMPLE 2

The procedure was as in example 2, except that the polyether alcohols were metered separately into the mixing head.

Table 1 gives the foaming performance and the mechanical properties of the foam.

TABLE 1

| | | Example | | | |
|---|---|---|---|---|---|
| | | 1 | 1 comp | 2 | 2 comp |
| Cell opening | | OK | pronounced | OK | very |
| | | | | | pronounced |
| Sedimentation | % | 1.0 | 1.5 | 1.0 | 2.5 |
| Visual assessment | | uniformly | non- | uniformly | unsatisfactory |
| of foam | | fine cell | uniformly | fine cell | cell structure, |
| | | structure | fine-pored | structure | small cracks |
| Test results | | | | | |
| Envelope density | kg/m³ | 27.4 | 27.2 | 28.3 | 27.6 |
| Indentation resistance B | | | | | |
| at 25% compression | N | 187 | 189 | 203 | 238 |
| at 40% compression | N | 260 | 261 | 291 | 328 |
| at 65% compression | N | 504 | 508 | 563 | 654 |
| Compressive strength | kPa | 4.5 | 4.5 | 5.2 | 5.6 |
| at 40% compression | | | | | |
| Tensile strength | kPa | 143 | 121 | 145 | 122 |
| Elongation at break | % | 185 | 177 | 170 | 138 |
| Compression set | % | 2.5 | 1.8 | 2.5 | 1.4 |
| Rebound resilience | % | 49.7 | 49.2 | 47.7 | 47.3 |
| Air permeability | mmWS | 5 | 12 | 7 | 22 |

comp—comparative example

The table shows that the foams produced by the inventive process have better processing properties and better mechanical properties than those which were produced by conventional processes.

1-6. (canceled)

7. A process for preparing mixtures of polyols for further processing to give a polyurethane, comprising at least one graft polyol, comprising mixing the at least one polyol between the preparation of the polyol and the preparation of the polyurethane, by means of a continuous mixing process.

8. The process according to claim 7, wherein the at least one graft polyol is a graft polyether alcohol.

9. The process according to claim 7, wherein the at least one graft polyol is a graft polyether alcohol.

10. A mixture of polyols for further processing to give polyurethanes, which are prepared according to claim 7.

11. The process for preparing polyurethanes comprising reacting
a) polyisocyanates with
b) compounds having at least two hydrogen atoms reactive toward isocyanate groups,
which comprises utilizing, as compounds b) having at least two hydrogen atoms reactive toward isocyanate groups, mixtures of polyols which comprise at least one graft polyol, and carrying out the mixing of the polyols between the preparation of the polyols and the preparation of the polyurethanes by means of a continuous mixing process with a static mixer.

12. A polyurethane obtained by the process according to claim 11.
